(19) United States
(12) Patent Application Publication
(10) Pub. No.: US 2003/0167309 A1
(43) Pub. Date: Sep. 4, 2003

(54) AUDIO-VISUAL MULTIMEDIA MESSAGE/DISCUSSION/BULLETIN SYSTEM AND METHOD

(76) Inventor: Mu-Hsiu Hsu, Taipei Shih (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,810

(22) Filed: Feb. 21, 2003

(30) Foreign Application Priority Data
Feb. 22, 2002 (TW) 91103105

(51) Int. Cl. G06F 15/16

(52) U.S. Cl. 709/206

(57) ABSTRACT

An audio-visual multimedia message/discussion/bulletin system. The system includes a wide area network, a user terminal and a server terminal. The user terminal further includes an editor and a browser. The server terminal includes a network server, an application server and an audio-visual server. The editor edits message/bulletins that contains both multimedia data and audio-visual data. The browser has a plug-in program for linking with the editor and submitting message/bulletins through the wide area network. The network server receives the message/bulletins submitted by the plug-in program through the wide area network and displays such message/bulletins in a web page language format on a web page. The application server has an analyzer/converter program. The analyzer/converter program analyzes the message/bulletins received by the network server and converts the message/bulletins into appropriate web page language format according to the result of analysis. The converted message/bulletins are submitted to the network server. The audio-visual server transmits the audio-visual file within the message/bulletins received by the network server to the browser through the wide area network.

### CROSS REFERENCE TO RELATED APPLICATIONS

This application claims the priority benefit of Taiwan application serial No. 91103105, filed on Feb. 22, 2002.

### BACKGROUND OF INVENTION

1. Field of Invention

The present invention relates to an audio-visual multimedia message/discussion/bulletin system and method. More particularly, the present invention relates to an audio-visual multimedia message/discussion/bulletin system and method that can be used on the Internet.

2. Description of Related Art

Ever since the Internet has become popular, discussion areas, message boards and bulletin listings have been a common means of communication between individuals and groups of people. Countless small or large, trivial or important topics are sent to discussion areas, message boards and bulletin columns so that ideas are shared and perspective communicated. Hence, these discussion areas, message boards and bulletin columns are a very important interface for information exchange.

At present, however, a pure textual format is used in the construction of such discussion areas, message boards and bulletin columns. If a user of the message/bulletin system wishes to attach a picture, the picture must meet the standard of the particular web page language format behind the generation of the discussion areas, message boards or bulletin columns. Hence, a user who needs to edit a message may encounter some difficulties. Since these purely textual message/bulletin systems or message/bulletins with picture-attach capability have severe limitations in information exchange, new types of systems are gradually developed. With the advent of broad bandwidth channels, prodigious amount of data can be transferred between stations. A message/bulletin system incapable of leaving audio, video, message and bulletin information inside the discussion areas, message boards or bulletin columns will become a big setback.

### SUMMARY OF THE INVENTION

Accordingly, one object of the present invention is to provide a message/discussion/bulletin system capable of using audio-visual multimedia to leave a message or bulletin note. The system only demands the use of a browser and yet is capable of preventing a user from having to use multiple hyperlinks to edit a multimedia message/bulletin. Furthermore, the multimedia message/bulletin system user does not need to worry about the incompatibility between the message/bulletin and the system supported web page language resulting in a sharing of the message/bulletin with other system users.

To achieve these and other advantages and in accordance with the purpose of the invention, as embodied and broadly described herein, the invention provides a multimedia message/discussion/bulletin system. The multimedia message/discussion/bulletin system includes a wide area network, a client user site, such as a user terminal, and a server terminal. The user terminal further includes an editor and a browser. The server terminal further includes a network server and an application server. The editor edits the message/bulletin containing multimedia data. The browser has a plug-in program. The plug-in program connects with the editor and transmits a message/bulletin to an external server through the wide area network. The network server receives the message/bulletin transmitted from the plug-in program via the wide area network and displays the message/bulletin in web page language format on the executing web page. The application server has an analyzer/program converter. The analyzer/program converter analyzes the message/bulletin received by the network server, converts the multimedia message/bulletin into web page format according to the analysis and then transmits the message/bulletin in the web page language format to the network server.

This invention also provides an alternative multimedia message/discussion/bulletin system. The system is capable of processing audio-visual data within a message/bulletin apart from processing multimedia data. The system includes a wide area network, a client user site, such as a user terminal, and a server terminal. The user terminal further includes an editor and a browser. The server terminal includes an audio-visual server aside from a network server and an application server. Connections of the wide area network, the editor, the browser, the network server, and the application server as well as their respective functions are similar to the aforementioned multimedia message/discussion/bulletin system. The additional audio-visual server is used for transmitting the audio-visual data received through the network server to the browser via the wide area network.

This invention also provides an audio-visual multimedia message/bulletin processing method related to the transmission of a message/bulletin upstream from a user terminal. A program is linked to an editor window and then the editor window edited message/bulletin is transmitted upstream. The message/bulletin contains both audio-visual data as well as multimedia data.

This invention also provides an audio-visual multimedia message/bulletin processing method related to the processing of a message/bulletin at a server terminal. An analysis of a received message/bulletin is performed to determine if the message/bulletin is in web page language format or not. The message/bulletin contains multimedia data. Thereafter, the message/bulletin is converted into a web page language format according to the result of analysis.

This invention also provides an audio-visual multimedia message/bulletin processing method related to an architectural arrangement at the user terminal and the server terminal for processing message/bulletin. A testing program is linked to an editor window and then the editor window edited message/bulletin is transmitted upstream. The message/bulletin contains both audio-visual data and multimedia data. An analysis of the received message/bulletin is next performed to determine if the message/bulletin is in web page language format or not. Thereafter, the message/bulletin is converted into a web page language format according to the result of analysis.

In brief, this invention provides an audio-visual multimedia message/discussion/bulletin system and method. When a user desires to leave a message in this system, a plug-in program embedded within the browser is activated to connect with a work processing software. The user may use the editor to edit the message/bulletin in the audio-visual multimedia. The edited audio-visual multimedia message/bulletin is then analyzed through the application server and converted into web page language format. Hence, system users may share the message/bulletin via the network server and the audio-visual server.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing a flow of the operations inside a multimedia message/discussion/bulletin system according to one preferred embodiment of this invention;

FIG. 2 is a block diagram showing an observational flow of the operations inside a multimedia message/discussion/bulletin system according to one preferred embodiment of this invention; and

FIG. 3 is a flow chart showing the steps carried out inside a multimedia message/discussion/bulletin system according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

This invention provides an audio-visual multimedia message/discussion/bulletin system capable of operating with the user terminal of a personal computer at the client user site, the user terminal of a personal digital assistant (PDA), a set-top box or a third generation cellular phone. The purpose is to provide each terminal user having a browser such as Microsoft”s Internet Explorer (IE) or Netscape”s browser and word editing software such as Microsoft”s Word or Microsoft”s Word editor to use their browser to transmit audio-visual multimedia message/bulletins through a wide area network. Furthermore, the user is able to edit the audio-visual multimedia message/bulletin through the browser. There is no need to link through multiple word editing software. Most importantly, the audio-visual multimedia message/bulletin can be immediately transmitted without having to change files after completing the message/bulletin editing process. In addition, there is no need to worry about incompatibility of the audio-visual multimedia message/bulletin with the system supported web language format.

According to the preferred embodiment of this invention, the audio-visual multimedia message/discussion/bulletin system can be divided into a user terminal and server terminal. The user terminal includes a browser and an editor. The server terminal includes a network server, an application server, a database server and an audio-visual server. The browser includes a plug-in program. The application server includes an analyzer/converter program written in an object oriented programming language (such as C#).

When a user uses a browser to access the open web page in this system through the wide area network, the system will automatically transmit the plug-in program and embed the program into the browser. Note that if the plug-in program is to incorporate into the browser through the user, transmission by the system is unnecessary.

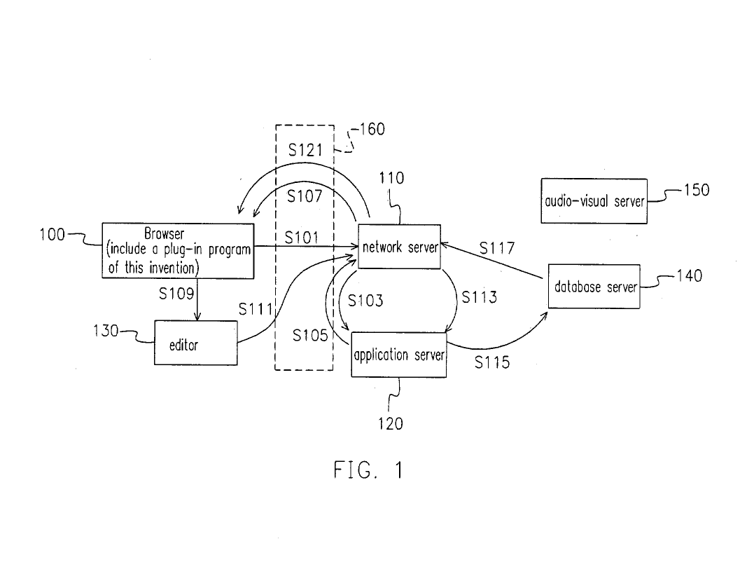

If the user has the plug-in program inside the browser for accessing the web page, message/bulletin may be selected from the web page. FIG. 1 is a block diagram showing a flow of the operations inside a multimedia message/discussion/bulletin system according to one preferred embodiment of this invention. When a user having the plug-in program inside the browser 100 proceeds onto the web page and picks up the message/bulletin item from the web page, the browser 100 will initiate a message/bulletin request to the network server 100 in step S101. The network server 110 enables the application server 120 in step S103. When the application server 120 is prepared for action, the application server 120 returns the message regarding the preparation of the application server 120 to the network server 110. In other words, the network server 110 is informed that the application server 120 is ready for operation in step S105.

On receiving a response from the application server 120, the network server 110 returns the message about readiness of the application server 120 to the browser 100 so that the plug-in program links up with the editor 130 that can edit the audio-visual multimedia message/bulletin. Hence, the user may edit any audio-visual multimedia message/bulletin. The editor 130 can be a word processing software such as Microsoft Word. In this embodiment, the plug-in program provides a link between a window screen and the editor 130. Through the window screen, a user may use the “insert object” option in the editor 130 to insert audio or video files into the editing message/bulletin in step S109. Hence, through the link option provided by the window screen, a user may edit the multimedia messages with ease.

After editing the audio-visual multimedia message/bulletin through the window screen, the user may click the “transmit message/bulletin” option. The plug-in program transmits the multimedia message/bulletin in standard format file (.doc) written by word editing software such as Microsoft Word to the network server 110 in step S111. Consequently, through the link option provided by the window screen, the edited audio-visual multimedia message/bulletin can be transmitted without having to go through multiple links.

On receiving the edited audio-visual multimedia message/bulletin transmitted from the plug-in program 130, the network server 110 retransmits the message/bulletin to the application server 120 in step S113.

On receiving the edited audio-visual multimedia message/bulletin, the application server 120 uses a built-in analyzer/converter program to analyze the edited message/bulletin and check whether the edited message/bulletin satisfies the web page language format or not. If the edited message/bulletin satisfies the web page language format, the application server 120 transmits the edited message/bulletin to the database server 140 directly. On the other hand, if the edited message/bulletin does not match the web language format, the application server 120 uses the built-in analyzer/converter to carry out a conversion so that the edited message/bulletin is converted into a suitable web page language format. The converted message/bulletin is next transferred to the database server 140 in step S115. To satisfy the requirement of a particular web page language format means meeting the web page language format of the Internet such as hypertext markup language (HTML) or extensible markup language (XML). At present, most web pages supported by the network server 210 are written either in HTML or XML. Using HTML as an example, if the .doc files used by the Word editing software are to satisfy HTML format, formulae, graphs, pictures . . . inside the .doc files must be converted into HTML specified format as shown in Table 1.

TABLE 1

| | |
|---|---|
| Word(.doc file) | HTML specified format |
| Formula | Gif File |
| Table | Gif File |
| Picture | Gif File |
| Text | Text File (may retain word form and format) |
| Audio | Such as WMA File |
| Video or Motion Picture | Such as WMV File |

Hence, the audio-visual multimedia message/bulletin in the HTML or XML format always satisfies the web page language format used by the network server.

The edited audio-visual multimedia message/bulletin in appropriate web page language format is transmitted from the application server and stored inside the database server 140. Thereafter, the message/bulletin is transferred to the network server 110 in step S117. On receiving the message/bulletin from the database server 140, the network server 110 posts the message/bulletin on a public web page so that any system users are free to browse. In the meantime, the network server 110 also transmits the message/bulletin to the browser 100 in step S121. After step S121, the user is able to see the edited audio-visual multimedia message/bulletin.

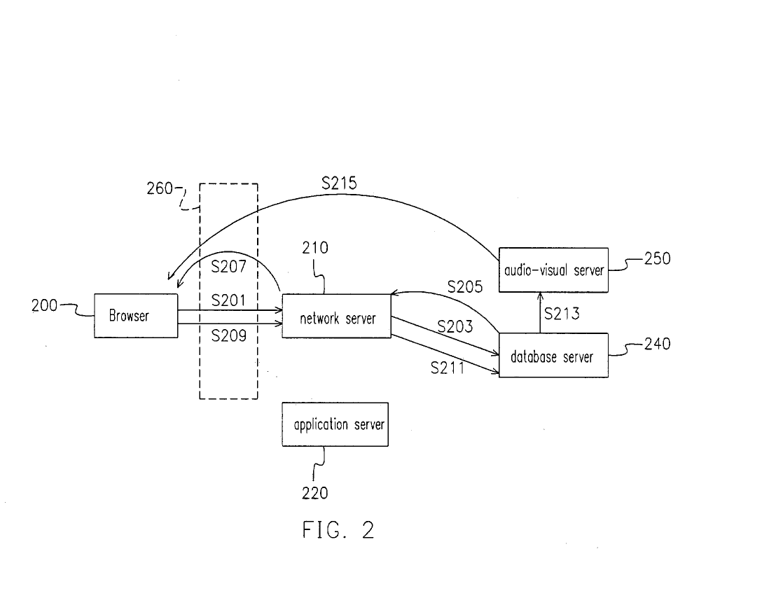

According to step S121, the system user may like to look at the audio-visual multimedia message/bulletin through the system. FIG. 2 is a block diagram showing an observational flow of the operations inside a multimedia message/discussion/bulletin system according to one preferred embodiment of this invention. When a system user (including the one who leaves the message/bulletin) steps into the public web page through the browser and selects the option of looking at the audio-visual multimedia message/bulletin, the browser 200 will submit a similar request to the network server 210 in step S201.

On receiving the request to see the audio-visual multimedia message/bulletin, the network server 210 will inform the database server 240 to issue the required audio-visual multimedia message/bulletin accordingly in step S203.

On receiving the request for looking at the audio-visual multimedia message/bulletin, the database server 240 will find the request message/bulletin internally and transmit the message/bulletin to the network server in step S205. On receiving the multimedia message/bulletin from the database server 240, the network server 210 will forward this message/bulletin to the browser 200 in step S207. After step S207, the system users are able to look at their requested audio-visual multimedia message/bulletin.

If, aside from looking at the desired audio-visual multimedia message/bulletin, the system user also likes to see the audio-visual file inside the audio-visual multimedia message/bulletin, the system user may select the hyperlink option of the audio-visual file. At the same time, the browser 200 will send out a request for viewing the audio-visual file to the network server 210 in step S209.

On receiving the request to see the audio-visual file, the network server 210 informs the database server 240 to transmit the corresponding audio-visual file in step S211.

On receiving the request to see the audio-visual file from the network server 210, the database server 240 retrieves the corresponding audio-visual file and transmits the file to the audio-visual server 250 in step S213. On receiving the audio-visual file from the database server 240, the audio-visual server 250 may transmit the audio-visual file directly or as a data stream to the browser in step S215. In this embodiment, the audio-visual file is sent to the browser 200 in a data stream.

Through step S215, the system user is able to look at the desired audio-visual multimedia message/bulletin and enjoy the audio and visual effects provided through the audio-visual file accompanying the audio-visual multimedia message/bulletin. Obviously, the system may be so designed that the corresponding audio-visual file is automatically transferred to the browser 200 for broadcasting when the user observes the audio-visual multimedia message/bulletin. In other words, steps S207 and S215 proceed in tandem.

Note that the network server 110/210 can be an IIS server or an Apache server and so on. However, because the Apache server is a charge free server for the user, the network server 110/210 used in this invention is an Apache server. The application server 120/220 can be a WebLogic server, a WebSphere server, an iPlanet server, a Tomcat server or a J-Boss server and so on. Similarly, here the application server 120/220 is a Tomcat server due to cost consideration. The database server 140/240 can be an SQL server, an Oracle server or a DB2 server and so on. Due to cost consideration, the database server 140/240 in this invention is an Oracle server.

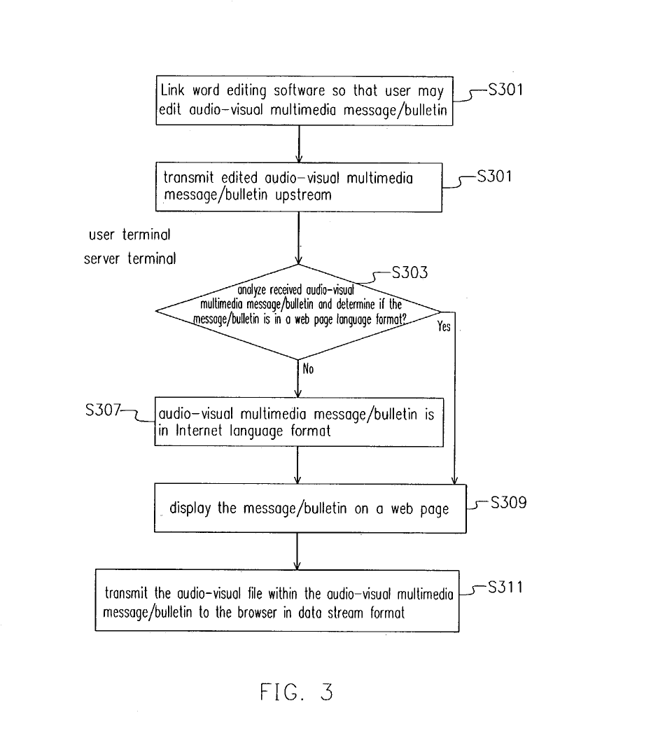

In addition, this invention also provides a method of shuttling message/bulletins between a user terminal and a server terminal. FIG. 3 is a flow chart showing the steps carried out inside a multimedia message/discussion/bulletin system according to one preferred embodiment of this invention.

When a user desires to edit an audio-visual multimedia message/bulletin through word editing software and transmit the message/bulletin to the server terminal via a wide area network, the user establishes a link with the word editing software through a browser in step S300. Thereafter, the edited message/bulletin is transmitted to the server terminal in step S301. The message/bulletin includes audio-visual information and multimedia information. The server terminal analyzes the received audio-visual multimedia message/bulletin and determines if the message/bulletin is in a web page language format or not in step S303. If the received audio-visual multimedia message/bulletin is in the web page language format, the audio-visual multimedia message/bulletin is displayed on the web page at the server terminal in step S309. On the other hand, if the received audio-visual multimedia message/bulletin is not in the web page language format, the message/bulletin is first converted into a web page language format in step S307. Thereafter, the converted audio-visual multimedia message/bulletin is displayed on the web page at the server terminal in step S309.

Finally, when a system user using a browser desires to look at the audio-visual file of a multimedia message/bulletin in a web page through a wide area network, the audio-visual file is transmitted in a data stream format to the browser for broadcasting in step S311.

In conclusion, this invention provides a multimedia message/discussion/bulletin system and method that can be used inside a personal computer, a personal digital assistant, a set-top box and a third generation cellular phone. Through a plug-in program to link up with a word editing software, a user may edit any audio-visual multimedia message/bulletin with ease. The edited audio-visual multimedia message/bulletin is converted into a common web page language format for the Internet through the application server. Hence, the user need not worry about the inability of the network server to support the message/bulletin file format. Ultimately, an easy-to-use environmental setup is provided for communicating audio-visual multimedia message/bulletins among students, entrepreneurs, customers, administrators and subordinates.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An audio-visual multimedia message/discussion/bulletin system, comprising:
a wide area network;
a client user site, comprising:
an editor for editing a message/bulletin, wherein the message/bulletin includes audio-visual data and multimedia data;
a browser having a plug-in program, wherein the plug-in program is used for linking with the editor and submitting the message/bulletin through the wide area network;
a server site, comprising:
a network server for receiving the message/bulletin submitted by the plug-in program through the wide area network and displaying the message/bulletin in web page language format on the web page;
an application server having an analyzer/converter program, wherein the analyzer/converter program analyzes the message/bulletin received by the network server and converts the message/bulletin into appropriate web page language format according to the results of analysis so that the message/bulletin in appropriate web page language format is transmitted to the network server; and
an audio-visual server for submitting the audio-visual information within the message/bulletin received by the network server through the wide area network to the browser.

2. The system of claim 1, wherein the client user site includes a personal computer, a personal digital assistant, a set-top box or a third generation cellular phone.

3. The system of claim 1, wherein the editor includes word editing software.

4. The system of claim 1, wherein the web page language format includes a hypertext markup language format.

5. The system of claim 1, wherein the web page language format includes an extensible markup language format.

6. The system of claim 1, wherein the application server further includes:
a database server for holding the message/bulletin in web page language format and transmitting the message/bulletin to the network server and the audio-visual server.

7. A multimedia message/discussion/bulletin system, comprising:
a wide area network;
a client user site, comprising:
an editor for editing a message/bulletin, wherein the message/bulletin includes multimedia data;
a browser having a plug-in program, wherein the plug-in program is used for linking up with the editor and transmitting the message/bulletin through the wide area network;
a server site, comprising:
a network server for transmitting the message/bulletin received from the plug-in program through the wide area network and displaying the message/bulletin in a web page language format on a web page; and
an application server having an analyzer/converter program, wherein the analyzer/converter program analyzes the message/bulletin received by the network server and converts the message/bulletin into an appropriate network page language format so that the message/bulletin in appropriate web page language format is submitted to the network server.

8. The system of claim 7, wherein the client user site includes a personal computer, a personal digital assistant, a set-top box or a third generation cellular phone.

9. The system of claim 7, wherein the editor includes a word editing software for editing the message/bulletin.

10. The system of claim 7, wherein the web page language format includes a hypertext markup language format.

11. The system of claim 7, wherein the web page language format includes an extensible markup language format.

12. A method of transmitting audio-visual multimedia message/bulletin upstream from a client user site to a server, comprising the steps of:
linking a message/bulletin program to an editor window; and
transmitting an edited message/bulletin upstream to the server, wherein the message/bulletin includes audio-visual data and multimedia data.

13. The method of claim 12, wherein the client user site includes a personal computer, a personal digital assistant, a set-top box or a third generation cellular phone.

14. The method of claim 12, wherein the editor window is driven by a word processing software.

15. A method of processing multimedia message/bulletins at a server site, comprising the steps of:
analyzing the received message/bulletin from a user and determining if the message/bulletin is in a web page language format or not, wherein the message/bulletin includes multimedia information; and
converting the multimedia message/bulletin into an appropriate web page language format according to the result of analysis.

16. The method of claim 15, wherein the web page language format is a hypertext markup language format.

17. The method of claim 15, wherein the web page language format is an extensible markup language format.

18. The method of claim 16, wherein the processing method further includes:
converting formulaic data inside the multimedia message/bulletin into a graphic interchange format file.

19. The method of claim 16, wherein the processing method further includes:
converting tabular data inside the multimedia message/bulletin into a graphic interchange format file.

20. The method of claim 16, wherein the processing method further includes:
converting picture data inside the multimedia message/bulletin into a graphic interchange format file.

21. The method of claim 16, wherein the processing method further includes:
converting information table data inside the multimedia message/bulletin into a table format file.

22. A method of processing audio-visual multimedia message/bulletins between a client user site and a server site, comprising the steps of:
linking a message/bulletin program to an editor window;
transmitting the edited message/bulletin upstream to the server, wherein the message/bulletin includes multimedia data and audio-visual data;
analyzing the received message/bulletin and determining if the message/bulletin is in a web page language format;
converting the message/bulletin into an appropriate web page language format according to the result of analysis; and
transmitting the audio-visual data portion of the message/bulletin.

23. The method of claim 22, wherein the processing method further includes:
transmitting the audio-visual data within the message/bulletin to the browser in a data stream format.

24. The method of claim 22, wherein the client user site includes a personal computer, a personal digital assistant, a set-top box or a third generation cellular phone.

25. The method of claim 22, wherein the processing method further includes:
linking the editor window through the program initiator and the word editor software.

26. The method of claim 22, wherein the web page language format is a hypertext markup language format.

27. The method of claim 22, wherein the web page language format is an extensible markup language format.

28. The method of claim 22, wherein the multimedia data includes formula, table data, picture data and information table data.

29. The method of claim 28, wherein the processing method further includes:
converting formulaic data inside the multimedia message/bulletin into a graphic interchange format file.

30. The method of claim 28, wherein the processing method further includes:
converting tabular data inside the multimedia message/bulletin into a graphic interchange format file.

31. The method of claim 28, wherein the processing method further includes:
converting picture data inside the multimedia message/bulletin into a graphic interchange format file.

32. The method of claim 28, wherein the processing method further includes:
converting information table data inside the multimedia message/bulletin into a table format file.
